(19) United States
(12) Patent Application Publication
(10) Pub. No.: US 2013/0064646 A1
(43) Pub. Date: Mar. 14, 2013

(54) STEAM TURBINE

(71) Applicant: Eckart Frehland, Konstanz (DE)

(72) Inventor: Eckart Frehland, Konstanz (DE)

(73) Assignee: Bio-System Gesellschaft fur Anwendugen Biologischer Verfahren mbH, Konstanz (DE)

(21) Appl. No.: 13/697,483

(22) PCT Filed: May 20, 2011
(86) PCT No.: PCT/EP11/58296

§ 371 Date: Nov. 12, 2012

(30) Foreign Application Priority Data
May 21, 2010 (DE) 102010017061.5

(51) Int. Cl. F01D 3/02; F16H 13/08; F01D 5/04

(52) U.S. Cl. 415/101; 416/185; 475/183

(57) ABSTRACT

A steam turbine having a mechanical power rating of up to 500 kW for powering a generator having a shaft, a steam inlet, and an open radial flow wheel, which is torque-resistantly connected to the shaft and can be impinged with steam by the steam inlet.

### RELATED APPLICATIONS

This application is a national phase filing of PCT/EP2011/058296 and as such claims priority to German Patent Application Serial Number 102010017061.5 filed May 21, 2010, which is herein incorporated by reference.

### FIELD OF THE INVENTION

The invention relates to a steam turbine, and in particular to a steam turbine according to the preamble of claim 1, as well as an apparatus for supporting a shaft according to a further independent claim herein.

### BACKGROUND

Steam turbines that convert thermal energy from steam, particularly superheated steam, into mechanical energy, which can then be converted further to electrical energy by means of a generator, are known from the prior art. Steam turbines of this kind are also known for small effective power values, meaning for wattages below 500 kW, wherein steam turbines that are known from the prior art have a shaft which has turbine blades disposed thereon. Steam is routed via a steam inlet in axial direction to the turbine blades in order to drive the shaft.

It is disadvantageous that such axial flow steam turbines can only be constructed for high wattages, if expenditures and efficiency are to be maintained in an acceptable range. For smaller mass flows, such axial flow steam turbines with axial cross-flow are expensive and may suffer, moreover, from poor efficiency.

Also known are blade wheels having the flow radially directed there-against, as known from, for example, DE 10 2008 052513. However, the apparatus with radial flow-off shown therein only demonstrates limited efficiency in applications involving low mass flows.

### SUMMARY OF THE INVENTION

A steam turbine substantially as shown in and/or described in connection with at least one of the figures herein, and as set forth more completely in the claims.

An object of the present invention seeks to ameliorate or remedy the disadvantages of the prior art. In particular, it is an object of the invention to provide a steam turbine for low mass flows or small power ratings that can be operated with good efficiency or can be easily manufactured or taken into operation.

These objects are achieved with a steam turbine according to claim 1. Such steam turbines are especially preferred for use in biogas plants that typically have less thermal output than conventional power reactors. Steam turbines according to the invention are especially expedient for utilizing exhaust heat after a combined heat-power stage in a biogas plant.

The steam turbine according to the invention has a mechanical power rating of up to 500 kW. The mechanical power rating herein denotes the output that the steam turbine is able to provide during permanent operation on its output shaft for powering a generator or directly to the shaft of a combustion engine. Especially preferred are steam turbines having even lower outputs because, with even smaller output power, the advantages of the technology of the present invention are more apparent in comparison with axial flow steam turbines. Preferably, steam turbines according to the invention have a mechanical power rating of up to 300 kW, especially preferred up to 150 kW, still more preferred up to 100 kW. Preferred embodied examples comprise open radial flow wheels, because they are able to achieve good efficiency. Further embodied examples comprise closed-type radial flow wheels. Preferably, the radial flow wheel is designed for an axial flow-off of the steam. A “radial inflow” of steam denotes the direction of flow of the steam of at least 45°, more preferred at least 70°, still more preferred at least 85° or 88°, in relation to the axial direction of the shaft from radially outside to inside.

The steam turbine preferably comprises an open radial flow wheel. Radial flow wheels offer the advantage of being able to achieve good efficiency even at low mass flows. The open construction allows for high circumferential velocities that, in turn, have a positive impact on efficiency. Moreover, high rotational speeds allow for smaller diameters which in turn allow for acceptable blade cross-sections at low mass flows. Thus to impinge the blade wheels on full circumference is possible, which is associated with further efficiency-related advantages.

Preferably, the steam inlet and the radial flow wheel are embodied such that the radial flow wheel can be fully impinged by the steam. Efficiency is thus improved. It is especially preferred for the steam inlet to comprise screw guide vanes for routing the steam to the radial flow wheel. This way, it is possible to achieve a flow against the blade with minimal losses. Guide vanes are preferably used.

Preferably, the steam turbine is embodied such that, when the steam turbine is operated at rated power output, the shaft has a speed of at least 50,000 revolutions per minute, preferably at least 70,000 revolutions per minute. High speeds have the advantage that they allow for increasing efficiency. Preferably, the circumferential velocity of the circumference of the radial flow wheel is at least 150 m/sec. This offers the advantage of being able to work at a high flow rate, thus allowing for good efficiency even at low active power.

According to some aspects of the invention, the steam turbine comprises a second radial flow wheel that is connected to the shaft in a torque-resistant manner. Preferably, the second radial flow wheel is also an open blade wheel. The second radial flow wheel offers the advantage that, using radial flow wheels with opposite-sense cross-flows, it is possible to equalize axial loads acting on the shaft.

The radial flow wheels are preferably disposed on opposite ends of the shaft. This offers the advantage that the bearing of the shaft can have a simpler construction, particularly in a preferred embodied example with radial flow wheels that are embodied such that the axial thrust of the radial flow wheels is at least substantially neutralized. Herein, preferably, the cross-flow of the steam traverses the radial flow wheels serially. It is preferred for one of the radial flow wheels to be larger than the other; it is especially preferred for the radial flow wheel located downstream to be larger than the radial flow wheel located upstream.

Preferably, a second steam inlet is provided for impinging the second radial flow wheel, wherein the steam inlet for a radial inflow of the steam onto the second radial flow wheel is disposed from the outside to the inside.

Preferred steam turbines comprise a first steam outlet for an axial flow-off of steam away from the first radial flow wheel. Furthermore, the steam turbine preferably comprises a second steam outlet for an axial flow-off of steam away from the second radial flow wheel.

Preferably, each of the two axial blade wheels constitutes a pressure stage, wherein a further shaft with two further radial flow wheels, which are supported cantilevered on the shaft ends and correspondingly receiving the flow, are provided for further pressure stages. The pressure stages are preferably set up as parallel or in series.

It is preferred that the shaft be supported in a cantilevered fashion. This way, steam can flow more easily to and away from the shaft. A further advantage of the opposite-lying position of the radial flow wheels is the fact that a vacuum pressure in one of the last turbine stages after the blade wheel is not able to reach the shaft seals. The shaft seals are disposed therein between the interior space of a housing and the steam passage. Furthermore, the shaft can be embodied as extremely short, whereby there results a high level of stiffness with a high natural frequency.

Preferably, the steam turbine comprises at least one stationary-supported planetary gear set with planetary friction gears for supporting the shaft. The planetary friction gears preferably comprise friction linings made of steel or ceramics. Steel or ceramics offer the advantage that they are able to withstand great loads. Preferably, two stationary-supported planetary gear sets are provided. The planetary friction gears preferably comprise one step or one stop collar. This offers the advantage that an axial support is possible by the interaction with a step on the shaft. The planetary friction gears have the advantage that support and simultaneous transmission of torque by the shaft and/or from the shaft is possible, and without any required use of gears. This way, it is possible to achieve a high speed of the shaft. Further typical embodied examples comprise, aside from the planetary friction gears, planetary gears for increasing the transferable torsional moments, wherein the preload of the friction gears can be reduced to zero.

The planetary gear set is preferably in an effective connection with a hollow shaft. With the preferably stationary-supported planetary gear set, the hollow shaft is powered in this manner by a rotation of the shaft of the steam turbine surrounding the planetary friction gears. The hollow shaft is preferably coaxially aligned with the shaft. The hollow shaft can be supported directly on the planetary friction gears or as an attachment to an internal friction gear. The internal friction gear or the hollow shaft preferably comprises a stop collar or a step. Preferred planetary friction gears with outer thrust rings thus allow for axially supporting the hollow shaft or the internal friction gear, such as they are also suitable for supporting the shaft.

Preferably, the hollow shaft comprises a drive ring gear. Preferred embodied examples of the hollow shaft have a two-part design. This ensures easy mounting of the hollow shaft. The outside lying part is preferably received inside a notch of the hollow shaft, preferably directed toward the outside. This way, it is possible for the output ring gear to have a small diameter whereby, acting in conjunction with the driven gear, a large gear ratio is achieved. This way, it is possible for the high speed of the steam turbine to be further stepped down in order to power a generator.

Preferably, a gear of an output shaft is in engagement with the output ring gear. For this purpose, the output shaft preferably has a ring gear with a larger diameter than the output ring gear of the hollow shaft.

Preferably, the steam turbine comprises a further set with two radial flow wheels that are disposed, torque-resistant, on a second shaft, wherein the second shaft also has an effective connection with the output shaft, particularly via a transmission, which is constructed analogously to the gear as described above, having planetary wheels, hollow shaft and external toothing. Similarly, third or further shafts can be provided with blade wheels and gears. This offers the advantage that it is possible to power using a compact construction with a plurality of radial flow wheels, which are preferably impinged in series with steam, a single output shaft.

A further aspect of the invention is a biogas plant having one of the above described or preferred steam turbines according to the invention. The steam turbine therein is advantageously used for residual energy usage of the thermal energy contained in exhaust gas.

A further independent aspect of the present invention relates to an apparatus for supporting a shaft, particularly a shaft having a rated speed in excess of 50,000 revolutions per minute with a shaft, two planetary gear sets that comprise, respectively, stationary rotably-supported planetary gears with cylinder-shaped surfaces that are smooth in the circumferential direction for supporting the shaft, and a hollow shaft supported on the planetary gear set. “Stationary rotably-supported” herein means that the planetary gears or planetary friction gears are supported on a fixed housing so as to only be able to rotate around their axis of rotation.

The planetary gear sets are preferably disposed such that the shaft is supported by the planetary gear sets as preloaded. The planetary gear sets are preferably embodied as planetary friction gear sets and thus serve for the transmission of moments. The planetary gears or planetary friction gears preferably have a steel surface, in particular, of surface-hardened or continuously hardened steel or ceramics.

Preferably, the hollow shaft comprises a force output-side that is disposed between the engagement circumferences with the planetary gear sets. The force output-side is advantageously disposed in a narrowing between the regions where the hollow shaft is in contact on the inner side with the planetary friction gears. This offers the advantage of a large gear ratio.

Preferably, the hollow shaft or the planetary gears or the shaft comprise a collar for axially guiding the shaft or the hollow shaft. This offers the advantage of the shaft to be simply supported in the axial direction.

Furthermore, typical embodied examples of the apparatus for supporting a shaft comprise characteristics that are disclosed in connection with the steam turbine with regard to the transmission and shaft support thereof, particularly additional planetary gears with ring gears having the same pitch diameter as the planetary friction gears, or an output shaft that is in engagement with the hollow shaft at the force output-side region. Similarly, preferred embodied examples are fitted with further shafts that are analogously supported and analogously engaging with the output shaft such that a plurality of shafts with large ratios act upon the one output shaft.

In typical embodied examples of the invention, the shaft is sealed between the inside of the housing, which receives the planetary gears, and the inside of the turbine housing by means of a gas-lubricated and spring-load axial seal, such as, for example, described in EP 2060804 A1. The disclosure of EP 2060804 A 1 with regard to the axial seal is made part of the present application.

In addition, in typical embodied examples, it is advantageously possible to provide a labyrinth seal. The labyrinth seal is preferably disposed on the pressure side, meaning on the side of the turbine housing, of the gas-lubricated seal in order to further improve the seal. This way, a reliable seal is achieved.

An independent aspect of the invention is the use of a gas-lubricated sealing means, particularly with an upstream labyrinth seal, for a steam turbine in an embodied example according to the invention or in a preferred embodied example.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Exemplary embodiments of the invention are explained in greater detail hereafter on the basis of the appended drawings, where in the drawings:

FIG. 1 is a schematic side view of a steam turbine according to one embodiment of the invention with an apparatus for supporting a shaft;

FIG. 2 is a schematic sectional view through the steam turbine of FIG. 1; and

FIG. 3 is a schematic side view of the steam turbine of FIG. 1.

### DESCRIPTION OF EMBODIMENTS

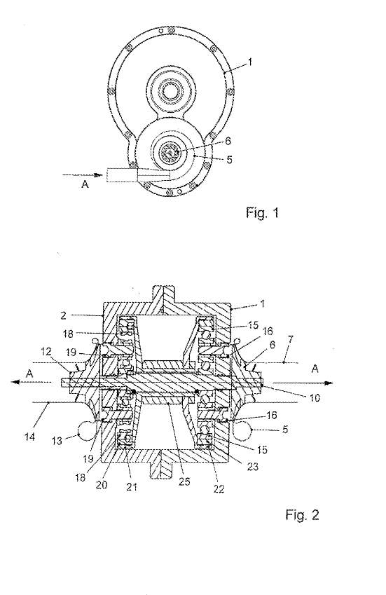

FIG. 1 shows a schematic side view of a steam turbine according to the invention with an apparatus according to the invention for supporting a shaft. The steam turbine comprises a housing of which FIG. 1 only includes a representation of one half of the housing 1.

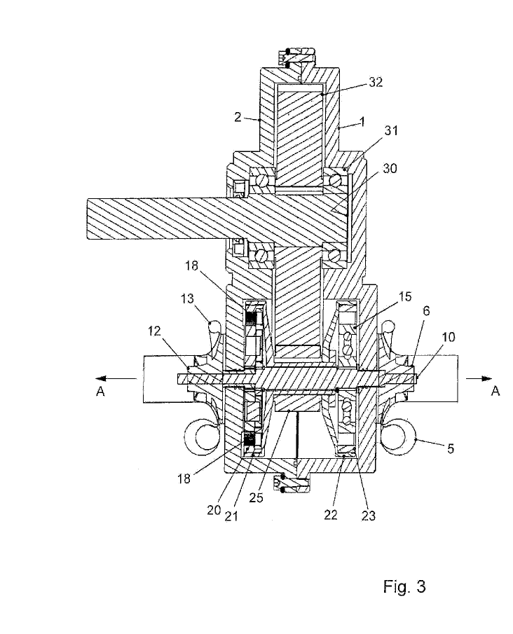

FIG. 2, which will be explained in connection with FIGS. 1 and 3, shows a section through the steam turbine of FIG. 1, wherein identical reference symbols in FIGS. 1 to 3 represent identical or similar parts herein and are not necessarily repeated for each description of a figure.

FIG. 2 also shows a sectional representation of the housing half 1, wherein the section of FIG. 2 extends through the lower region of the steam turbine of FIG. 1. Furthermore, FIG. 2 shows a second housing half 2 that is connected to the first housing half 1 by a flanged connection.

FIG. 1 contains, moreover, as a schematic top view, a first inlet screw 5, which is part of a steam inlet for impinging a first radial flow wheel 6. The radial flow wheel 6 is only partially depicted in FIG. 1. Visible are parts of the radial flow wheel 6 through an outlet pipe 7. The outlet pipe 7 is used as a steam outlet in order to remove axially flowing off steam of the first radial flow wheel 6.

The first radial flow wheel 6 is supported by a shaft 10, wherein a second radial flow wheel 12 is disposed on the opposite end of the shaft 10. The second radial flow wheel 12 is disposed opposite in relation to the first radial flow wheel 6 and subject to full steam impingement via a second inlet screw 13. Similarly, a second steam outlet 14 is provided. Arrows that are marked by an “A” provide a schematic representation of the direction of flow of the steam.

FIG. 2 also contains a schematic representation of the manner in which the shaft 10 is supported by two planetary friction sets. The shaft is not directly supported on the housing halves 1 and 2; instead, it is supported exclusively by the planetary friction sets. On the side of the housing half 1, the shaft 10 is supported by a first planetary friction gear set; of those, two first planetary friction gears 15 in FIG. 2 are schematically, and by means of a sectional view, depicted. The first planetary friction gears 15 are supported on support screws 16 that are disposed inside the housing half 1. A step or stop collar in the shaft 10 provides an axial support for the shaft 10. It must be considered therein that the axial forces acting upon the shaft 10 are very minimal, due to the radial flow wheels 6 and 12 that are disposed opposite of each other. The shaft 10 with the planetary friction gear sets are typical elements of the apparatus according to the invention for supporting the shaft 10. The subsequent explanation of the details regarding the support and the speed reduction of the shaft to the output shaft are also, in the same way, characteristics of a typical embodied example of an apparatus according to the invention for supporting a shaft. This apparatus is also suitable for use for other purposes than inside a steam turbine, particularly for fast-turning shafts, that must be transmitted relative to an output shaft.

The side of housing half 2 features a mirror-image of the array with a second planetary friction gear set. The second planetary friction gears 18 are supported on two support screws 19 in the housing half 2. The second planetary friction gears 18 are equipped on their inner side, for supporting the shaft 10, with a step for the axial support of shaft 10. A hollow wheel 20 is disposed at the outer circumference on the second planetary friction gears 18, which supports a second partial shaft 21 of a hollow shaft. The hollow shaft comprises, furthermore, a first partial shaft 22 that is disposed on a first hollow wheel 23, supported by the first friction gear set.

The two partial shafts 21 and 22 constitute one hollow shaft upon which there is disposed an output ring gear 25. The reason for the two-part hollow shaft is the fact that, due to the necking wherein the output ring gear 25 is disposed, the hollow shaft cannot be placed on the two friction gear sets in one piece. The two hollow wheels 20 and 23 are similarly supported like the shaft 10 on the two planetary friction gear sets.

Typical embodied examples of the invention comprise, in addition to the friction gear sets, planetary gear sets with ring gears in order to improve a moment transfer from the shaft to the hollow shaft. Further typical embodied examples of the invention comprise steam passages for routing the flow-off steam of the first radial flow wheel in the inlet screw for impingement of the second radial flow wheel.

The simultaneous support and speed reduction of the shaft by means of two planetary friction gear sets and a force output-side on a separate hollow shaft that is, in turn, supported on the two hollow wheels of the planetary friction gear sets, offers various advantages. For example, it is possible to implement support and force transmitting functions at high gear ratio simultaneously. Preferably, at least three stationary friction gears are disposed as planetary gears per planetary friction gear set, thus at least six per shaft.

The axial support occurs preferably by stop collars or steps, respectively, of the shaft and the hollow wheels and/or the hollow shaft on the hollow shaft at the outer thrust rings of the stationary planetary gears. This way, it is possible to achieve a simple construction with force-transmitting symmetry and minimal losses due to friction.

The bearings of the friction gears are preferably embodied as roller bearings having, due to the ratio from the shaft to the friction gears, a substantially lesser speed than the shaft. The shaft itself is of short construction length thus having a high natural frequency and high level of inflexibility.

The embodiment as shown in FIG. 3 is the same as depicted in FIG. 1, shown once more in a schematic side view, wherein FIG. 3 shows a vertical section of the steam turbine of FIG. 1. For an explanation, reference is made in a supplementary fashion to the previous explanations regarding FIGS. 1 and 2.

FIG. 3 shows an output shaft 30 that is supported by roller bearings 31 in the housing halves 1 and 2. The output shaft carries a gear 32, which is in engagement with the output ring gear 25 of the hollow shaft. Due to the fact that the diameter of the gear 32 is substantially larger than the diameter of the output ring gear 25 and the same, in turn, is substantially smaller than the diameter of the internal gears 20 and 23, a further gear ratio from the planetary friction gears 15 and 18 to the output shaft 30 is achieved.

The present invention is not limited to the previously described typical embodiment; rather, the scope of the invention is defined by the claims.

1-15. (canceled)

16. A steam turbine, particularly having a mechanical power rating of up to 500 kW for powering an apparatus, comprising:
a shaft;
a steam inlet;
a first radial flow wheel torque-resistantly connected to the shaft at a first end of the shaft so as to be impinged with steam via the steam inlet, wherein, for a radial inflow of the steam onto the first radial flow wheel, the steam inlet is disposed from the outside to the inside; and
a second radial flow wheel torque-resistantly connected to the shaft at a second end of the shaft opposite to the first end of the shaft.

17. The steam turbine according to claim 16, wherein the steam inlet and the radial flow wheel are embodied such that the radial flow wheel can be completely loaded with steam.

18. The steam turbine according to claim 16, wherein, upon operation of the steam turbine with a power rating thereof, the shaft has a speed of at least 50,000 revolutions per minute.

19. The steam turbine according to claim 16, further including a second steam inlet for impinging the second radial flow wheel, wherein the second steam inlet is arranged for a radial inflow of the steam to the second radial flow wheel from the outside to the inside.

20. The steam turbine according to claim 16, further including a first steam outlet for an axial flow-off of steam from the first radial flow wheel.

21. The steam turbine according to claim 16, wherein the first and second radial flow wheels are supported on the shaft as cantilevered.

22. The steam turbine according to claim 16, further including a stationary-supported planetary gear set with planetary friction gears for supporting the shaft.

23. The steam turbine according to claim 22, wherein the planetary gear set comprises planetary gears parallel to the planetary friction gears.

24. The steam turbine according to claim 22, wherein the planetary gear set is in an operative connection with a hollow shaft.

25. The steam turbine according to claim 24, wherein the hollow shaft is supported on the planetary friction gears.

26. The steam turbine according to claim 24, wherein the hollow shaft includes an outside-lying output ring gear.

27. The steam turbine according to claim 26, including two further radial flow wheels of one or a plurality of further parallel and/or serially connected pressure stage, the further radial flow wheels being disposed with torque-resistance on a second shaft or a plurality of further shafts, wherein the shaft and the second and further shafts are in an operative connection with a ring gear of an output shaft.

28. An apparatus for supporting a shaft, particularly a shaft having a rated speed in excess of 50,000 revolutions per minute, comprising:
a shaft;
two planetary gear sets that comprise, respectively, stationary rotationally supported planetary gears with a smooth, cylinder-shaped surface in a circumferential direction for supporting the shaft; and
a hollow shaft that is supported on the planetary gear sets.

29. The apparatus according to claim 28, wherein the hollow shaft includes a force output-side region that is disposed between engagement circumferences with the planetary gear sets.

30. The apparatus according to claim 29, wherein at least one of the hollow shaft, the planetary gears or the shaft comprise a collar for the axial guidance of at least one of the shaft or the hollow shaft.
